(19) United States
(12) Patent Application Publication
(10) Pub. No.: US 2010/0125512 A1
(43) Pub. Date: May 20, 2010

(54) NETWORK-ACCESSIBLE VIRTUAL SHOPPING CART

(75) Inventors: David Jones, Seattle, WA (US); Ovidiu Temereanca, Sammamish, WA (US); Mark John Sawrey Leece, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/273,955

(22) Filed: Nov. 19, 2008

(51) Int. Cl. G06Q 30/00; G06F 17/30

(52) U.S. Cl. 705/27; 705/26

(57) ABSTRACT

The network-accessible virtual shopping cart includes shopping for digital content with a portable device. The portable device receives an instruction to add a digital content item to a virtual shopping cart. If a network connection to a network-accessible virtual shopping cart is available, the digital content item is added to the network-accessible virtual shopping cart. If a network connection to the network-accessible virtual shopping cart is not available, the digital content item is added to a local virtual shopping cart. Upon the network-accessible virtual shopping cart becoming available, digital content items are moved from the local virtual shopping cart to the network-accessible virtual shopping cart.

### BACKGROUND

Digital media can be enjoyed using portable devices configured to store, organize, and playback songs, videos, games, and other forms of digital media. In fact, the variety of digital media that can be enjoyed on such devices is becoming overwhelming. As the portable device platform becomes more ubiquitous, it becomes increasingly beneficial to provide users with an easy-to-use shopping experience for acquiring new digital media.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Various embodiments related to a network-accessible virtual shopping cart are discussed herein. One disclosed embodiment includes shopping for digital content with a portable device. An instruction to add a digital content item to a virtual shopping cart can be received by the portable device. The embodiment further includes, if a network connection to a network-accessible virtual shopping cart is available, adding the digital content item to the network-accessible virtual shopping cart. The embodiment further includes, if a network connection to the network-accessible virtual shopping cart is not available, adding the digital content item to a local virtual shopping cart. The embodiment further includes, upon the network-accessible virtual shopping cart becoming available, moving digital content items from the local virtual shopping cart to the network-accessible virtual shopping cart.

### BRIEF DESCRIPTION OF THE DRAWINGS

FIG. 1 shows a block diagram of an example portable device interacting with a network-accessible server.

FIG. 2 shows a block diagram of an example portable device downloading a sample of a digital content item peer-to-peer from another portable device.

FIG. 3 shows an example method of shopping for digital content with a portable device.

FIG. 4 shows another example method of shopping for digital content with a portable device.

### DETAILED DESCRIPTION

A portable device may be used to store, download, organize, and play digital content items such as songs, movies, and games. Digital content items may include, for example, digital audio, digital video, digital images, games, ringtones, and the like.

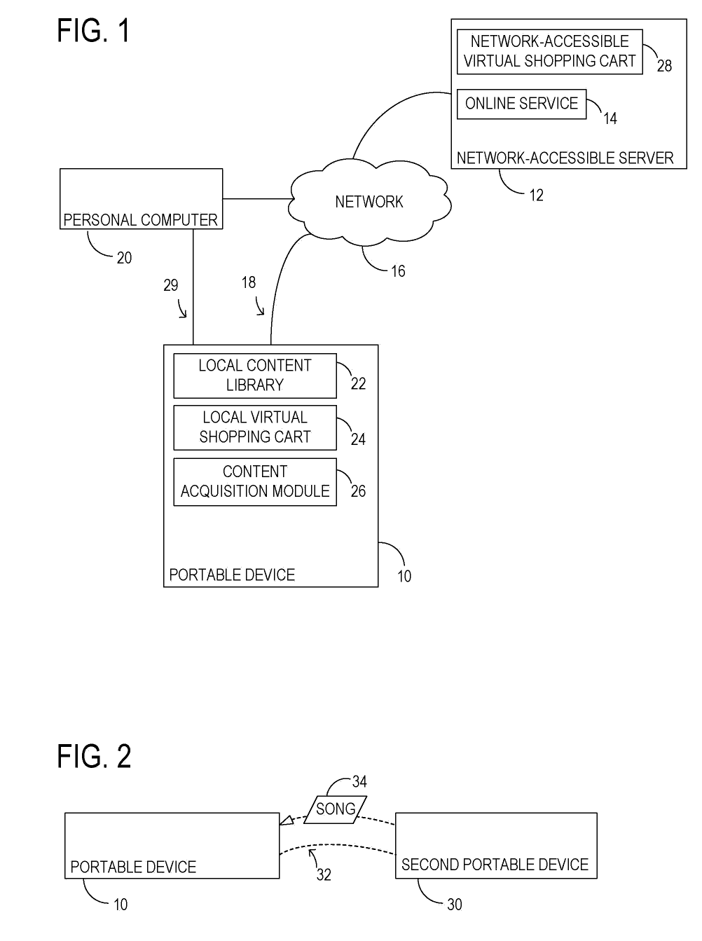

FIG. 1 shows a block diagram of an example portable device 10 interacting with a network-accessible server 12. For example, portable device 10 may interact with network-accessible server 12 when shopping for media content using an online service 14.

As shown in FIG. 1, portable device 10 accesses the network-accessible server 12 via a network 16. In some scenarios, portable device 10 may access network 16 via a radio connection 18. For example, portable device 10 may access network 16 using a wireless radio network connection such as an 802.11x wireless hotspot and/or a cellular network.

In some scenarios, portable device 10 may additionally or alternatively access network-accessible server 12 via a personal computer 20, as further shown in FIG. 1. For example, portable device 10 may establish a wired or wireless connection to personal computer 20. Thus, portable device 10 accesses network-accessible server 12 via personal computer 20, where personal computer 20 is configured to access network-accessible server 12 via network 16. Personal computer 20 may access network 16 via any suitable method without departing from the scope of this disclosure.

The configuration shown in FIG. 1 is exemplary. In other examples, the portable device 10 may interact with an online service via different, or even no, intermediate routing agents. In some embodiments, the online service may itself include two or more components, which may optionally be distributed across different machines and/or locations.

In the illustrated example, portable device 10 includes a local content library 22, a local virtual shopping cart 24, and a content acquisition module 26. When using portable device 10 to shop for digital content, portable device 10 may download media content items from online service 14 to local content library 22. For example, in response to receiving from a user an instruction to add a digital content item to a virtual shopping cart, such a digital content item may be added to the virtual shopping cart where it can be paid for and then downloaded from the online service 14 to the local content library 22 of the portable device 10 (e.g., directly, via personal computer 20, and/or via another suitable channel). In other scenarios, free digital content items may be downloaded without using a virtual shopping cart.

As used herein, placing a digital content item in a virtual shopping cart includes the concept of placing an identifier of the digital content item in the virtual shopping cart without placing the underlying media data in the virtual shopping cart. For example, if a user wishes to purchase a song in the form of an MP3 file, the user may instruct the portable device to place the song in the virtual shopping cart, thus causing an identifier of that song to be placed in the virtual shopping cart without placing the actual MP3 file in the virtual shopping cart. At a later time, as part of the shopping transaction, the MP3 file may be placed in the local content library of the portable device.

Portable device 10 may download a sample digital content item from an online service 14 offering sample digital content items. For instance, a user may download a time-limited sample version of a song from an online service. Upon playing the sample version on the portable device, the user may decide to purchase a full version of the song from the online service. As such, the user may give the portable device an instruction to add a full version of the digital content item corresponding to the sample digital content item.

In other examples, portable device 10 may receive a sample of the digital content item from promotional media data, and the user of portable device 10 may then decide to download a full version. In yet other examples, portable device 10 may download a sample of the digital content item peer-to-peer from another portable device 30 via a wired or wireless connection, such as radio connection 32 shown in FIG. 2. As an example, a friend may recommend a song 34 to a user and transfer a sample version of song 34 from second portable device 30 to portable device 10. Upon listening to song 34, the user may decide to purchase a full version of song 34.

In the exemplary scenario shown in FIG. 1, if the network connection to network-accessible virtual shopping cart 28 is available, then the content acquisition module 26 may add the digital content item to the network-accessible virtual shopping cart 28 in response to receiving an instruction to add a digital content item to a virtual shopping cart.

However, the instruction to add the digital content item to the virtual shopping cart may also be received when the network-accessible virtual shopping cart 28 is not available. If the network connection to the network-accessible virtual shopping cart 28 is not available, then the content acquisition module 26 may add the digital content item to a local virtual shopping cart 24.

Upon determining that the network connection to network-accessible virtual shopping cart 28 is available, content acquisition module 26 is configured to move digital content items from local virtual shopping cart 24 to network-accessible virtual shopping cart 28.

In some cases, network-accessible virtual shopping cart 28 becomes available responsive to portable device 10 establishing a network connection to network-accessible virtual shopping cart 28. In such cases, the digital content items are moved from local virtual shopping cart 24 to network-accessible virtual shopping cart 28 via the network connection.

For example, upon deciding to purchase a full version of the song, the user may use a user interface of the portable device to provide an instruction to purchase the song. If the network-accessible server is not available to the portable device, then the song is placed into the local virtual shopping cart on the portable device, and the purchase may be resumed at a later time. Upon establishing a connection to the network-accessible server at a later time, the song may be transferred from the local virtual shopping cart to the network-accessible virtual shopping cart.

Additionally, upon network-accessible virtual shopping cart 28 becoming available, and digital content items being moved to network-accessible virtual shopping cart 28, digital content items may be deleted from local virtual shopping cart 24.

Shopping for digital content with portable device 10 may further include downloading the digital content item to a local content library 22. For example, upon purchasing a digital content item from an online source, the digital content item may be downloaded to a local library on the portable device that, for example, stores and organizes digital content items.

As described above, portable device 10 may also access network-accessible server 12 via a personal computer 20. In such a scenario, when shopping for digital content with portable device 10 and upon receiving an instruction to add a digital content item to a virtual shopping cart, the portable device may add the digital content item to a local virtual shopping cart 24. A connection 29 between portable device 10 and personal computer 20 may be established such that the digital content item may be transferred from local virtual shopping cart 24 to network-accessible virtual shopping cart 28 via personal computer 20 and/or the personal computer's network connection.

For example, if the user in the aforementioned example had not established a network connection to the network-accessible server to continue with the shopping experience, the user may establish a connection with a personal computer (e.g., to sync the portable device 10 with personal computer 20), and the digital content item may be transferred from the local virtual shopping cart to network-accessible virtual shopping cart 28 via personal computer 20 and/or the personal computer's network connection. In other words, network-accessible virtual shopping cart 28 is accessible to portable device 10 via personal computer 20 and network 16. Network-accessible virtual shopping cart 28 may become available responsive to portable device 10 being docked to personal computer 20.

Network-accessible virtual shopping cart 28 is accessible by the personal computer 20 and configured to receive the digital content item from local virtual shopping cart 24 of portable device 10 via personal computer 20. In such a case, the digital content item may be moved from portable device 10 and/or personal computer 20 to the network-accessible virtual shopping cart 28 via a network connection.

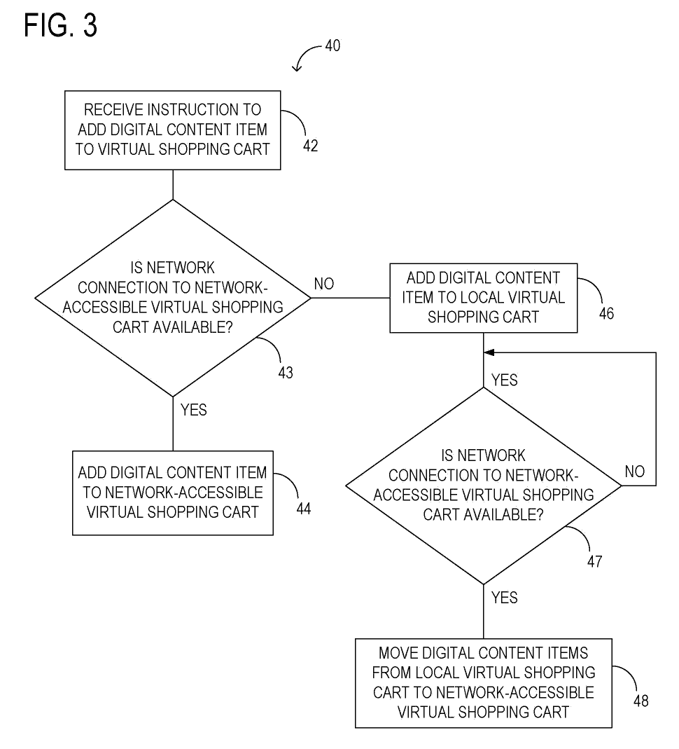

FIG. 3 shows a method 40 of shopping for digital content with a portable device. At 42, method 40 includes receiving an instruction to add a digital content item to a virtual shopping cart. At 43, it is determined if a network-accessible virtual shopping cart is available. At 44, method 40 includes, if a network connection to a network-accessible virtual shopping cart is available, adding the digital content item to the network-accessible virtual shopping cart. At 46, method 40 includes, if a network connection to the network-accessible virtual shopping cart is not available, adding the digital content item to a local virtual shopping cart. At 47, it is determined if the network-accessible virtual shopping cart has become available. At 48, method 40 includes, upon the network-accessible virtual shopping cart becoming available, moving digital content items from the local virtual shopping cart to the network-accessible virtual shopping cart. If the network-accessible shopping cart has not yet become available, method 40 may loop back to 47, where it can again be determined if the network-accessible virtual shopping cart has become available. Availability of the network-accessible virtual shopping cart can be tested according to a predetermined schedule or in response to a predetermined event (e.g., docking with a personal computer and/or establishing an Internet connection).

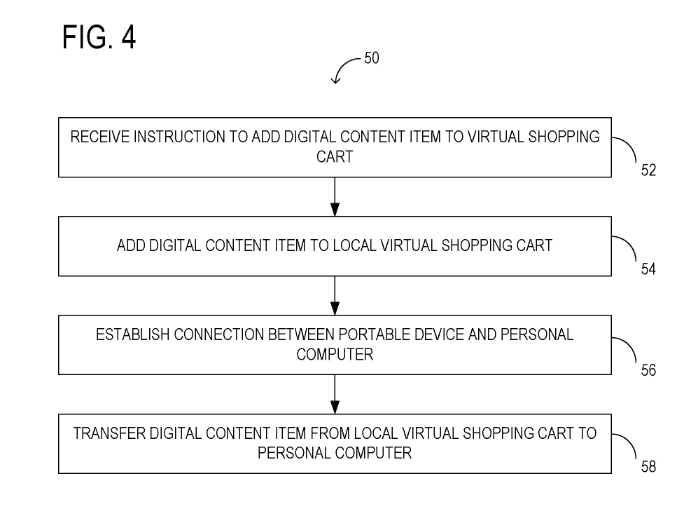

FIG. 4 shows a method 50 of shopping for digital content with a portable device. At 52, method 50 includes receiving an instruction to add a digital content item to a virtual shopping cart. At 54, method 50 includes adding the digital content item to a local virtual shopping cart. At 56, method 50 includes establishing a connection between the portable device and a personal computer. At 58, method 50 includes transferring the digital content item from the local virtual shopping cart to the personal computer.

It should be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of shopping for digital content with a portable device, the method comprising:
receiving an instruction to add a digital content item to a virtual shopping cart;
if a network connection to a network-accessible virtual shopping cart is available, adding the digital content item to the network-accessible virtual shopping cart;
if a network connection to the network-accessible virtual shopping cart is not available, adding the digital content item to a local virtual shopping cart; and
upon the network-accessible virtual shopping cart becoming available, moving digital content items from the local virtual shopping cart to the network-accessible virtual shopping cart.

2. The method of claim 1, where the network-accessible virtual shopping cart becomes available responsive to the portable device being docked to a personal computer.

3. The method of claim 2, where digital content items are moved from the local virtual shopping cart to the network-accessible virtual shopping cart via the personal computer.

4. The method of claim 1, where the network-accessible virtual shopping cart becomes available responsive to the portable device establishing a network connection to the network-accessible virtual shopping cart.

5. The method of claim 4, where digital content items are moved from the local virtual shopping cart to the network-accessible virtual shopping cart via the network connection.

6. The method of claim 1, where the instruction to add the digital content item to the virtual shopping cart includes receiving an instruction to add the digital content item when the network-accessible virtual shopping cart is not available.

7. The method of claim 1, further comprising downloading the digital content item to a local content library.

8. The method of claim 1, further comprising, upon the network-accessible virtual shopping cart becoming available, deleting digital content items from the local virtual shopping cart.

9. The method of claim 1, further comprising determining if a network connection to the network-accessible virtual shopping cart is available.

10. The method of claim 1, further comprising downloading a sample digital content item.

11. The method of claim 10, where the sample digital content item is downloaded peer-to-peer from another portable device.

12. The method of claim 10, where the sample digital content item is downloaded from an online service offering sample digital content items.

13. The method of claim 10, where receiving the instruction to add the digital content item to the virtual shopping cart includes receiving an instruction to add a full version of the digital content item corresponding to the sample digital content item.

14. A portable device, comprising:
a local content library;
a local virtual shopping cart; and
a content acquisition module configured to:
add a digital content item to a network-accessible virtual shopping cart if a network connection to the network-accessible virtual shopping cart is available;
add the digital content item to the local virtual shopping cart if the network connection to the network-accessible virtual shopping cart is not available; and
update the network-accessible virtual shopping cart with digital content items from the local virtual shopping cart upon the network-accessible virtual shopping cart becoming available.

15. A method of shopping for digital content with a portable device, the method comprising:
receiving an instruction to add a digital content item to a virtual shopping cart; adding the digital content item to a local virtual shopping cart;
establishing a connection between the portable device and a personal computer; and
transferring the digital content item from the local virtual shopping cart to the personal computer.

16. The method of claim 15, where a network-accessible virtual shopping cart is accessible by the personal computer and configured to receive the digital content item from the portable device via the personal computer.

17. The method of claim 16, where the network-accessible virtual shopping cart becomes available responsive to the portable device establishing the connection to the personal computer.

18. The method of claim 16, where the digital content item is moved from the personal computer to the network-accessible virtual shopping cart via a network connection.

19. The method of claim 16, further comprising downloading the digital content item to a local content library.

20. The method of claim 15, further comprising downloading a sample digital content item.
